(19) United States
(12) Patent Application Publication
(10) Pub. No.: US 2014/0372446 A1
(43) Pub. Date: Dec. 18, 2014

(54) EMAIL CONTENT MANAGEMENT AND VISUALIZATION

(71) Applicant: International Business Machines Corporation, Armonk, NY (US)

(72) Inventors: Denise A. Bell, Austin, TX (US); Lisa Seacat DeLuca, Baltimore, MD (US); Jana H. Jenkins, Raleigh, NC (US)

(21) Appl. No.: 13/917,725

(22) Filed: Jun. 14, 2013

(51) Int. Cl. G06F 17/30

(52) U.S. Cl. CPC G06F 17/30713
USPC 707/740

(57) ABSTRACT

Embodiments of the present invention provide a system, method, and program product to manage and visualize email content using metadata tags. In an embodiment, the method comprises a computing device receiving an email message that is addressed to a recipient and includes a metadata tag; associating the metadata tag with a predefined category and/or subcategory; transmitting a predefined category and/or subcategory to be displayed using at least a pie chart icon that includes a circular chart divided into sectors that illustrate a numerical portion of the transmitted predefined category and/or subcategory associated with a metadata tag, wherein each sector includes an arc length that is proportional to a quantity of email messages received that have a metadata tag associated with the sector; and generating an object associated with the transmitted predefined category and/or subcategory, wherein in response to a user interacting with the object an action is generated.

### FIELD OF THE INVENTION

The present invention relates generally to the field of email content management and visualization, and more particularly to managing and visualizing email content using metadata tags.

### BACKGROUND OF THE INVENTION

Electronic mail (hereinafter “email”) is a popular form of communication used by individuals for business and personal purposes. An email is composed by a sender and transmitted from the sender to one or more recipients identified by an email address included in the “To”, “Carbon copy” and/or “Blind carbon copy” fields of the email. An email contains predefined descriptive metadata tags (hereinafter “tag”) that describes various aspects of the email. A tag is a non-hierarchical keyword or term assigned to a piece of information, for example, an email field. Email is traditionally displayed within a plain database/table format in which each row of the display corresponds to a single message or thread. Users can separate email into different searchable folders by using tags that reflect a criteria, such as work, associated with the email.

A tagging system is different than a traditional hierarchical system wherein a designer defines a limited number of terms to use for classification, and there is one correct way to classify each item. In a tagging system, there are an unlimited number of ways to classify an item, such as an email, and there is no wrong choice. Hence, instead of belonging to one category, an email may have several different tags associated with it.

### SUMMARY

Embodiments of the present invention provide a system, method, and program product to manage and visualize email content using metadata tags. In an embodiment, the method comprises a computing device receiving an email message that includes a metadata tag, and wherein the email message is addressed to a recipient. The method further comprises, for each email message received, the computing device associating the metadata tag with a predefined category and/or subcategory. Further still, the method comprises the computing device transmitting a predefined category and/or subcategory to be displayed using at least a pie chart icon that includes a circular chart divided into sectors that illustrate a numerical portion of the transmitted predefined category and/or subcategory associated with a metadata tag, wherein each sector includes an arc length that is proportional to a quantity of email messages received by the computing device that have a metadata tag associated with the predefined category and/or subcategory the sector represents. Furthermore, the method comprises the computing device generating an object associated with the transmitted predefined category and/or subcategory, wherein in response to a user interacting with the object an action is generated.

### BRIEF DESCRIPTION OF THE SEVERAL VIEWS OF THE DRAWINGS

FIG. 1 is a block diagram illustrating an environment, in accordance with an embodiment of the present invention.

FIG. 2A depicts a portion of a mailbox included in an email information store of FIG. 1, in accordance with an embodiment of the present invention.

FIG. 2B depicts the email transmitted by a sender included in FIG. 2A, in accordance with an embodiment of the present invention.

FIG. 3 depicts several pie charts generated by a program function of FIG. 1, in accordance with an embodiment of the present invention.

FIG. 4 is a flowchart depicting the operational steps of a program function, on a mail server within the environment of FIG. 1, for managing and visualizing email content using metadata tags, in accordance with an embodiment of the present invention.

FIG. 5 depicts a block diagram of components of a mail server of FIG. 1, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

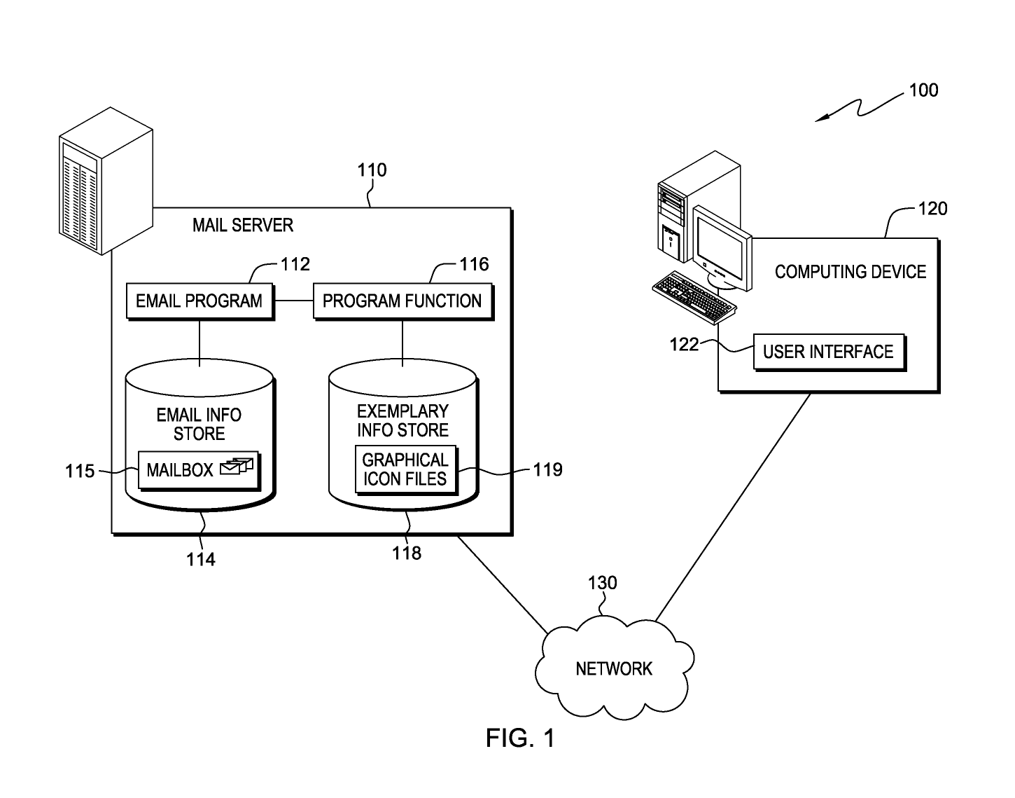

Embodiments of the present invention will now be described in detail with reference to the Figures. FIG. 1 is a block diagram illustrating an environment, generally designated 100, in accordance with one embodiment of the present invention.

Environment 100 includes computing device 120 and mail server 110, all interconnected over network 130. Network 130 can be, for example, a local area network (LAN), a wide area network (WAN) such as the Internet, or a combination of the two, and can include wired, wireless, or fiber optic connections. In general, network 130 can be any combination of connections and protocols that will support communications between mail server 110 and computing device 120. In various embodiments of the present invention, computing device 120 and mail server 110 may be a laptop computer, tablet computer, netbook computer, personal computer (PC), a desktop computer, a personal digital assistant (PDA), or a smart phone.

Computing device 120 is in communication with mail server 110 via network 130. Computing device 120 is a computing device utilized to access and manipulate electronic mail (hereinafter “email) included in mail server 110. Computing device 120 includes user interface 122, which is used by the user of computing device 120 to access and manipulate email included in mail server 110. Mail server 110 is in communication with computing device 120 via network 130. Mail server 110 is a computing device capable of receiving tagged email, in accordance with an embodiment of the present invention. Mail server 110 includes email program 112 and program function 116. Mail server 110 can, via network 130, transmit data to computing device 120 for display.

Email program 112 is in communication with email information store 114 and program function 116. Email program 112 is mail transfer agent software that receives email associated with a user of computing device 120 utilizing a transfer protocol, for example, the Simple Mail Transfer Protocol. Email information store 114 is an information repository. Email information store 114 includes mailbox 115, which includes email received by email program 112 that is addressed to the user of computing device 120. In other embodiments, email information store 114 is in communication with email server 110 via network 130.

Email program 112 receives, via network 130, email addressed to the user of computing device 120, wherein each email includes at least one metadata tag (hereinafter “tag) that describes one or more aspects of the information included in the received email. A tag is a non-hierarchical keyword or term that is assigned to a piece of information, for example, information included in an email field (discussed further below). In an embodiment, email received by email program 112 includes tags that reflect one or more of a date, time, email message recipient, email message sender, geographic location of the email message sender, relationship between email message sender and email message recipient, geospatial information, email message subject, and whether the received email message is unread. In another embodiment, email program 112 can further tag and/or categorize email included in email information store 114 according to a user defined criteria.

In an embodiment, using a contact list associated with the user of computing device 120 (not shown), email program 112 can associate a user defined tag with received email included in mail box 115, according to administrative information included in the contact list, for example, the addressor's organization. In general, email program 112 can be any email program capable of receiving email that includes at least one tag, in accordance with an embodiment of the present invention.

Exemplary information store 118 is in communication with program function 116. Exemplary information store 118 is an information repository that includes graphical icon files 119, which are utilized by program function 116 to display predetermined categories and/or subcategories, as well as, tags associated with tagged email included in mail box 115. In an embodiment, graphical icon files 119 include a graphical icon that is a circular chart divided into sectors (hereinafter “pie chart”) that illustrates a numerical portion of an item, for example, a category, subcategory, or tag, such that the arc length of each sector is proportional to a quantity associated with the item. In another embodiment, graphical icon files 119 include a line chart, plot, chart, diagram, or any graphic that depicts the relationship between two or more categories, subcategories, and/or tags.

Program function 116 is in communication with email program 112 and exemplary information store 118. Program function 116 represents software that generates a graphical depiction of predetermined categories and/or subcategories, as well as, tags associated with email. Program function 116 monitors email received by email program 112 addressed to the user of computing device 120.

Program function 116 assigns tagged email included in mailbox 115 to a predetermined category and/or subcategory, for example, work, sports, spam, project XYZ, read, unread, and important. Program function 116 transmits a graphical depiction of at least one predetermined category and/or subcategory to be displayed, for example, via user interface 122, utilizing at least the pie chart included in graphical icon files 119, such that the arc length of each sector is proportional to the quantity of email messages that have tags associated with the category and/or subcategory the sector represents. In another embodiment, program function 116 transmits a graphical depiction of at least one tag utilizing at least the pie chart included in graphical icon files 119, such that the arc length of each sector is proportional to the quantity of email messages that have tags that the sector represents.

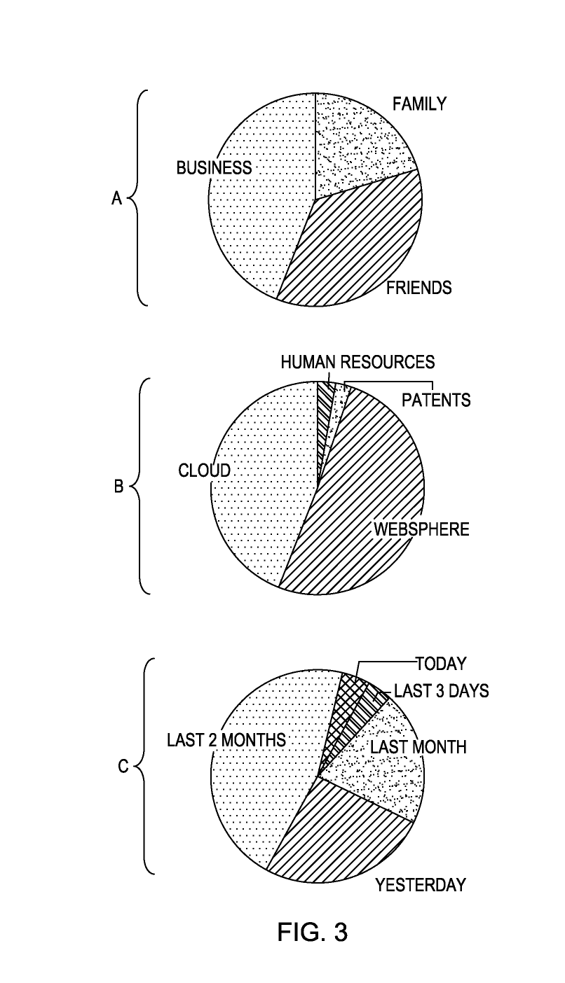

Program function 116 generates an object associated with a sector, wherein in response to input generated by, for example, user interface 122, which is associated with the sector, program function 116 generates an action (discussed below in reference to FIG. 3), for example, the generation of an additional pie chart, such as the pie chart included in graphical icon files 119. In an embodiment, program function 116 generates the additional pie chart such that the quantity that is associated with a sector of the generated additional pie chart is the quantity of emails included in mailbox 115 that include metadata tags associated with the category and/or subcategory the displayed sector represents. In yet another embodiment, program function 116 generates the additional pie chart such that the quantity that is associated with a sector of the generated additional pie chart is the quantity of email messages received within a predetermined time frame. In yet still another embodiment, program function 116 generates the additional pie chart such that the quantity that is associated with a sector of the generated additional pie chart is the quantity of email messages included in mailbox 115 that have been read or are unread. Program function 116 can determine tags that describe information included in email stored in mailbox 115. In an additional embodiment, the action generated by program function 116 includes deletion of emails that include the metadata tag or predefined category and/or subcategory associated with the displayed sector.

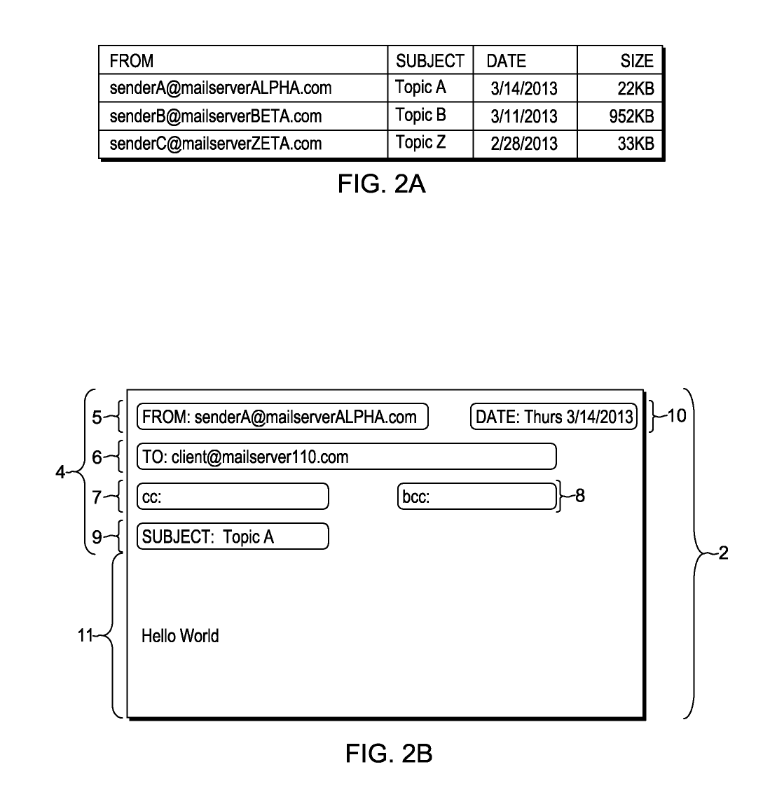

Concepts introduced in the following discussion of FIGS. 2A and 2B will be used further in the discussion of FIG. 3 in the context of environment 100 of FIG. 1. FIG. 2A depicts a portion of mailbox 115 included in email information store 114 of FIG. 1, in accordance with an embodiment of the present invention. Specifically, FIG. 2A, depicts a portion of mailbox 115 that includes three (3) emails from three (3) different email senders, senderA@mailserverALPHA.com, senderB@mailserverBETA.com, senderC@mailserverZETA.com. FIG. 2A also depicts several fields, for example, FROM, SUBJECT, DATE, and SIZE. The email sent from senderA@mailserverALPHA.com will be used further in the discussion of FIG. 2B.

FIG. 2B depicts the email transmitted by senderA@mailserverALPHA.com of FIG. 2A, in accordance with an embodiment of the present invention. In particular, FIG. 2B depicts email 2, which includes message header 4 and message body 11. Message header 4 includes fields 5 through 10 that store administrative information. Field 5 stores the sender's email address, senderA@emailserverALPHA.com. Field 6 stores the recipient's email address, while fields 7 and 8 store carbon copy and blind carbon copy information, respectively. Field 9 stores the subject that describes the email, such as “Topic A.” Lastly, message body 11 stores the content of the email, for example, “Hello World.” In an embodiment, program function 116 can determine the metadata included in email message fields 4 through 11. In another embodiment, fields 5 through 11 contain information that relates to tags. In an embodiment, program function 116 determines tags associated with an email message field included in an inbox. For example, program function 116 determines that field 9 is associated with a user defined tag called “Topic A.”

FIG. 3 depicts several pie charts generated by program function 116 of FIG. 1, in accordance with an embodiment of the present invention. Program function 116 generates illustration A, which reflects the quantity of email included in mail box 115 that include tags that are associated with three (3) predetermined categories, Business, Family, and Friends. For example, program function 116 determines that mailbox 115 includes tagged email addressed to the user of computing device 120 received via network 130 by email program 112. Program function 116 generates a list of predetermined categories and subcategories for display. For example, program function 116 retrieves a list that includes predetermined categories and/or subcategories from exemplary information store 118 and transmits them, via network 130, for display, for example, via user interface 122. In an embodiment, the list generated by program function 116 includes tags that describe the information included in an email field, for example, email fields 4 through 11 of FIG. 2B.

Subsequent to determining which categories and/or subcategories are selected for display, for example, Business, Family, and Friends, program function 116 determines which tags are associated with the selected predetermined categories and/or subcategories. For example, program function 116 accesses a directory, for example, Lightweight Directory Access Protocol (LDAP) directory, or a social networking friends list associated with the user of computing device 120 and using information included in Field 5, which denotes the email sender field, of each email included in mailbox 115 determines which email includes a Business, Family, and/or Friend contact in Field 5 and assigns the email to the appropriate category, such as Business, Family, or Friends. Program function 116 transmits, via network 130, the selected predetermined categories and/or subcategories for display, for example, on user interface 122, using at least a pie chart included in graphical icon files 119.

For example, program function 116 transmits, via network 130, the selected predetermined categories and/or subcategories for display on user interface 122 using the pie chart included in graphical icon files 119 such that each section of the pie chart is associated with a particular selected predetermined category and/or subcategory. Further, the arc length of a section is proportional to a quantity, such as the quantity of emails included in mailbox 115 that include a tag associated with the selected predetermined category and/or subcategory. Hence, illustration A reflects the number of emails included in mailbox 115 that have a tag associated with the selected predetermined categories and/or subcategories.

Illustration B depicts a pie chart icon generated by program function 116 that reflects the number of emails included in mailbox 115 that include tags associated with the Business predetermined category of illustration A. In particular, illustration B shows that Cloud, Human Resources, Patents, and WebSphere are tags associated with the Business predetermined category. Hence, illustration B reflects that email that includes a “Cloud” tag comprises roughly fifty (50) percent of the email included in the Business predetermined category depicted in illustration A. Illustration B also reflects that email included in mailbox 115 that includes a WebSphere tag comprises the second largest percentage of the email included in the Business predetermined category depicted in illustration A. For example, to generate the pie chart of illustration B program function 116 determines the quantity of email included in mailbox 115 that have a particular tag, for example, a Cloud tag, and program function 116 depicts the determined quantity in the arc length of the pie chart section associated with the tag. Illustration C reflects additional detail of the email included in the section that corresponds to the Business predetermined category of illustration A.

Illustration C is a pie chart generated by program function 116 that depicts additional information associated with Cloud tagged emails of illustration B. In particular, illustration C is a pie chart generated by program function 116 wherein each section of the pie chart corresponds to a particular receipt time frame, for example, Today, Last 3 days, Last month, Yesterday, and Last 2 months, for Cloud tagged email included in mailbox 115. For example, program function 116 generates an object, such as an additional pie chart, associated with the Cloud section depicted in the pie chart of illustration B, in response to receiving input associated with the Cloud section of illustration B. For example, the received input is generated by a user selecting the Cloud section via user interface 122. In response to detecting the input, program function 116 determines the receipt date of each email included in the Cloud section of the pie chart of illustration B and assigns that email to the appropriate email receipt time frame section in the additional pie chart of illustration C.

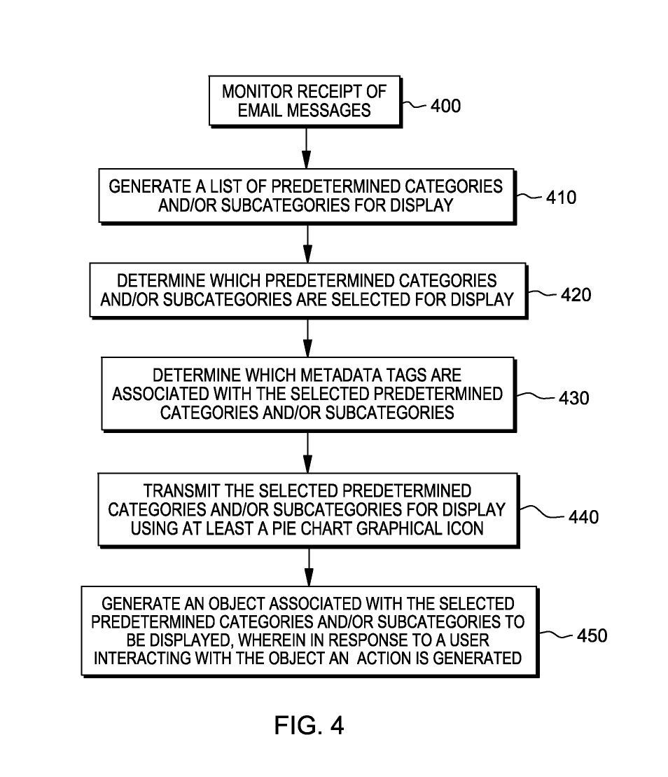

FIG. 4 is a flowchart depicting the operational steps of program function 116, on mail server 110 within environment 100 of FIG. 1, for managing and visualizing email content using metadata tags, in accordance with an embodiment of the present invention. Program function 116 monitors receipt of email messages (step 400). Program function 116 generates a list of predetermined categories and/or subcategories for display (step 410). Program function 116 determines which predetermined categories and/or subcategories are selected for display (step 420). Program function 116 determines which metadata tags are associated with the selected predetermined categories and/or subcategories (step 430). Program function 116 transmits the selected predetermined categories and/or subcategories for display using at least a pie chart icon (step 440). Program function 116 generates an object associated with the selected predetermined categories and/or subcategories to be displayed, wherein in response to a user interacting with the object an action generated (step 450).

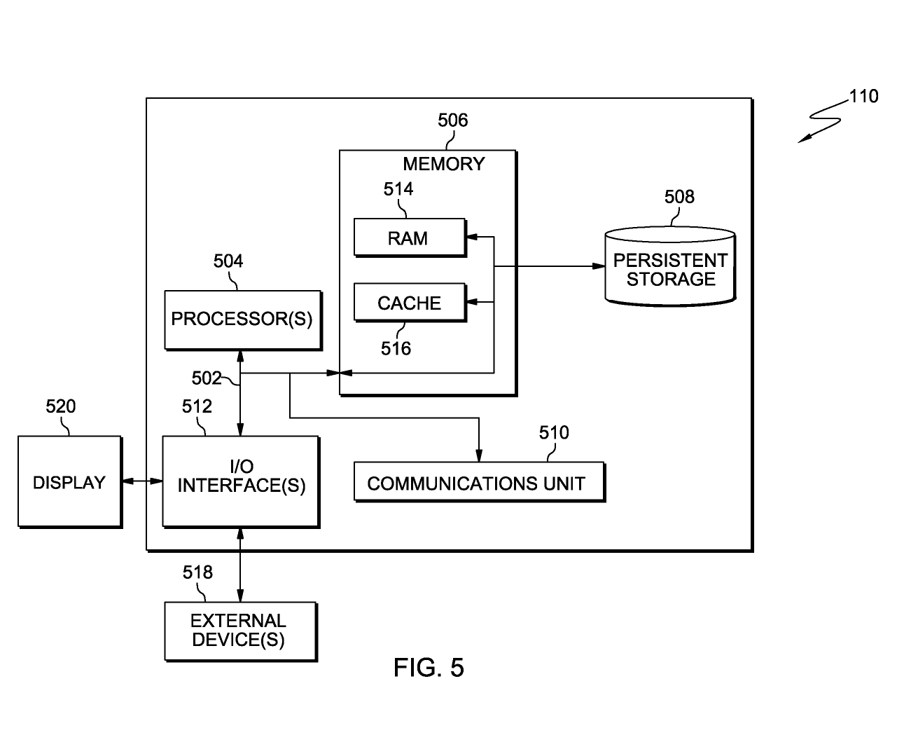

FIG. 5 depicts a block diagram of components of mail server 110 of FIG. 1, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Mail server 110 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Program function 116, email program 112, exemplary information store 118, and email information store 114 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including computing device 120. In these examples, communications unit 510 includes one or more network interface cards. Communications unit 510 may provide communications through the use of either or both physical and wireless communications links. Program function 116 and email program 112 may be downloaded to persistent storage 508 through communications unit 510.

I/O interface(s) 512 allows for input and output of data with other devices that may be connected to mail server 110. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., program function 116, can be stored on such portable computer-readable storage media and can be loaded onto persistent storage 508 via I/O interface(s) 512. I/O interface(s) 512 also connects to a display 520. Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method comprising:
receiving, by a computing device, an email message that includes a metadata tag and is addressed to a recipient;
for each email message received, associating the metadata tag with a predefined category and/or subcategory;
transmitting a predefined category and/or subcategory to be displayed using at least a pie chart icon that includes a circular chart divided into sectors that illustrate a numerical portion of the transmitted predefined category and/or subcategory associated with a metadata tag, wherein each sector includes an arc length that is proportional to a quantity of email messages received by the computing device that have a metadata tag associated with the predefined category and/or subcategory the sector represents; and
generating an object associated with the transmitted predefined category and/or subcategory, wherein in response to a user interacting with the object an action is generated.

2. The method of claim 1, wherein the action generated includes the generation of an additional pie chart icon for display that includes a circular chart divided into sectors that illustrate a numerical portion of the metadata tags associated with the transmitted predefined category and/or subcategory, and wherein each sector includes an arc length that is proportional to a quantity of email messages that include the metadata tag associated with the transmitted predefined category and/or subcategory.

3. The method of claim 1, wherein the action generated includes the generation of an additional pie chart icon for display that includes a circular chart divided into sectors that illustrate a predetermined time frame, and wherein each sector includes an arc length that is proportional to a quantity of email messages received by the computing device that is associated with the predetermined time frame the sector represents.

4. The method of claim 1, wherein the action generated includes the generation of an additional pie chart icon for display that includes a circular chart divided into sectors that illustrate a numerical portion of the transmitted predefined category and/or subcategory, and wherein each sector includes an arc length that is proportional to a quantity of read or unread email messages received by the computing device that include metadata tags that are associated with the transmitted predefined category and/or subcategory.

5. The method of claim 1, wherein the metadata tag included in the received email message reflect one or more of a date, time, email message recipient, email message sender, geographic location of the email message sender, relationship between email message sender and email message recipient, geospatial information, email message subject, and whether the received email message is unread.

6. A computer program product comprising a computer-readable storage medium having program code embodied therewith, the program code executable by a processor to:
receive an email message that includes a metadata tag and is addressed to a recipient;
for each email message received, associate the metadata tag with a predefined category and/or subcategory;
transmit a predefined category and/or subcategory to be displayed using at least a pie chart icon that includes a circular chart divided into sectors that illustrate a numerical portion of the transmitted predefined category and/or subcategory associated with a metadata tag, wherein each sector includes an arc length that is proportional to a quantity of email messages received by a computing device that includes the processor, and wherein the email messages received include a metadata tag associated with the predefined category and/or subcategory the sector represents; and
generate an object associated with the transmitted predefined category and/or subcategory, wherein in response to a user interacting with the object an action is generated.

7. The computer program product of claim 6, wherein the program code to generate the action includes program code to generate an additional pie chart icon for display that includes a circular chart divided into sectors that illustrate a numerical portion of the metadata tags associated with the transmitted predefined category and/or subcategory, and wherein each sector includes an arc length that is proportional to a quantity of email messages that include the metadata tag associated with the transmitted predefined category and/or subcategory.

8. The computer program product of claim 6, wherein the program code to generate the action includes program code to generate an additional pie chart icon for display that includes a circular chart divided into sectors that illustrate a predetermined time frame, wherein each sector includes an arc length that is proportional to a quantity of email messages received by a computing device that includes the processor, and wherein the email messages received are associated with the predetermined time frame the sector represents.

9. The computer program product of claim 6, wherein the program code to generate the action includes program code to generate an additional pie chart icon for display that includes a circular chart divided into sectors that illustrate a numerical portion of the transmitted predefined category and/or subcategory, wherein each sector includes an arc length that is proportional to a quantity of read or unread email messages received by a computing device that includes the processor, and wherein the read or unread email messages received include metadata tags that are associated with the transmitted predefined category and/or subcategory.

10. The computer program product of claim 6, wherein the metadata tag included in the received email message reflect one or more of a date, time, email message recipient, email message sender, geographic location of the email message sender, relationship between email message sender and email message recipient, geospatial information, email message subject, and whether the received email message is unread.

11. A computer system comprising:
one or more computer processors;
one or more computer-readable storage media;
program instructions stored on the computer-readable storage media for execution by at least one of the one or more processors, the program instructions comprising:
program instructions to receive an email message that includes a metadata tag and is addressed to a recipient;
for each email message received, program instructions to associate the metadata tag with a predefined category and/or subcategory;
program instructions to transmit a predefined category and/or subcategory to be displayed using at least a pie chart icon that includes a circular chart divided into sectors that illustrate a numerical portion of the transmitted predefined category and/or subcategory associated with a metadata tag, wherein each sector includes an arc length that is proportional to a quantity of email messages received by a computing device that includes the one or more processors, and wherein the email messages received include a metadata tag associated with the predefined category and/or subcategory the sector represents; and
program instructions to generate an object associated with the transmitted predefined category and/or subcategory, wherein in response to a user interacting with the object an action is generated.

12. The computer system of claim 11, wherein the program instructions to generate the action include program instructions to generate an additional pie chart icon for display that includes a circular chart divided into sectors that illustrate a numerical portion of the metadata tags associated with the transmitted predefined category and/or subcategory, and wherein each sector includes an arc length that is proportional to a quantity of email messages that include the metadata tag associated with the transmitted predefined category and/or subcategory.

13. The computer system of claim 11, wherein the program instructions to generate the action include program instructions to generate an additional pie chart icon for display that includes a circular chart divided into sectors that illustrate a predetermined time frame, wherein each sector includes an arc length that is proportional to a quantity of email messages received by a computing device that includes the one or more computer processors, and wherein the email messages received are associated with the predetermined time frame the sector represents.

14. The computer system of claim 11, wherein the program instructions to generate the action include program instructions to generate an additional pie chart icon for display that includes a circular chart divided into sectors that illustrate a numerical portion of the transmitted predefined category and/or subcategory, wherein each sector includes an arc length that is proportional to a quantity of read or unread email messages received by a computing device that includes the one or more computer processors, and wherein the read or unread email messages include metadata tags that are associated with the transmitted predefined category and/or subcategory.

15. The computer system of claim 11, wherein the metadata tag included in the received email message reflects one or more of a date, time, email message recipient, email message sender, geographic location of the email message sender, relationship between email message sender and email message recipient, geospatial information, email message subject, and whether the received email message is unread.
